(19) United States
(12) Patent Application Publication
(10) Pub. No.: US 2015/0334812 A1
(43) Pub. Date: Nov. 19, 2015

(54) DESIGN TO MANAGE CHARGE AND DISCHARGE OF WAFERS AND WAFER CARRIER RINGS

(71) Applicants: John Mazzocco, San Jose, CA (US); Daniel Greenberg, San Jose, CA (US)

(72) Inventors: John Mazzocco, San Jose, CA (US); Daniel Greenberg, San Jose, CA (US)

(21) Appl. No.: 14/280,530

(22) Filed: May 16, 2014

(51) Int. Cl. H05F 3/04; B25J 19/00; B25J 15/00

(52) U.S. Cl. CPC H05F 3/04; B25J 15/0019; B25J 19/00

(57) ABSTRACT

Embodiments of the invention include methods and apparatuses for removing charge from a carrier ring assembly. Embodiments include picking up a carrier ring assembly from a first location with an end effector. The charge is removed from the carrier ring assembly by one or more charge regulating surfaces formed on an end effector. According to an embodiment the charge regulating surfaces may be pads formed above top surfaces of an end effector blade. Embodiments include charge regulating surfaces that cover the entire surface of the end effector blade. Embodiments include removing charge from a carrier ring of an end effector assembly, and from a substrate supported on a conductive adhesive backing tape surrounded by the carrier ring. In an embodiment, the carrier ring assembly is then transferred to a second location with the end effector.

### BACKGROUND

1) Field

Embodiments of the present invention pertain to the field of semiconductor processing and, in particular, to methods and apparatuses for controlling the discharge of a carrier ring.

2) Description of Related Art

Substrates may acquire a static charge during processing. For example, when a silicon wafer is processed by a plasma etching chamber, the silicon wafer obtains a static charge. Problems may arise during subsequent substrate handling or processing if the static charge is not removed from the substrate. For example, when a silicon wafer develops a static charge, it may have a strong attraction to the end effector or a chuck on which the substrate is placed in a subsequent process. The attraction may be strong enough to bind the substrate to the surface, and removal would require a force large enough to potentially fracture the substrate. Accordingly, the charge needs to be dissipated from the substrate. One such process of charge removal includes the use of a conductive probe to contact the substrate in order to provide a pathway to remove the charge. However, an arc may form and damage the circuitry formed on the substrate if the charge is drained at a rate that is too fast. For example, contacting a charged substrate with a material that has a high conductivity, such as a metallic material, will dissipate the current within several microseconds and will cause arcing between the materials.

### SUMMARY

Embodiments of the invention include systems and methods for controlling the discharge of a charged carrier ring assembly.

According to an embodiment, a method of removing the charge from a carrier ring assembly includes picking up a carrier ring assembly that has acquired a charge. For example, the charge may be acquired during a processing operation, such as a plasma process. The method further includes transferring the carrier ring assembly to a second location with an end effector that includes charge regulating surfaces. In an embodiment, the charge regulating surfaces are pads formed over a top surface of the end effector.

In an embodiment, picking up the carrier ring assembly from the first location includes contacting a portion of a conductive adhesive backing tape surrounded by a carrier ring with the charge regulating surfaces. In such embodiments, charge is removed from the carrier ring and from a substrate supported on the conductive adhesive backing tape. Further embodiments include a substrate that includes a plurality of die that were diced prior to the carrier ring assembly being picked up at the first location, and where the charge is removed from each of the die.

Embodiment of the invention further include an end effector for removing the charge from a carrier ring assembly. In an embodiment, the end effector is coupled to an end effector wrist. In an embodiment, one or more charge regulating surfaces are formed on the end effector. In embodiments of the invention, the charge regulating surfaces include a plurality of pads. For example, the pads may support a bottom surface of the carrier ring assembly. In an embodiment, an insulative layer is formed over the exposed surfaces of the end effector. Additional embodiments include charge regulating surfaces that are positioned to contact a carrier ring of a carrier ring assembly, and a conductive adhesive backing tape of a carrier ring assembly. Embodiments also include an end effector that is made from a charge regulating material. The charge regulating surface may also be a surface coating applied over a core material. Embodiments of the invention include charge regulating surfaces that include one or more of carbon doped polyether ether ketone (PEEK), titanium doped alumina, titanium nitride, titanium oxide, and diamond like coatings.

### BRIEF DESCRIPTION OF THE DRAWINGS

FIG. 1 is an illustration of a carrier ring assembly that includes a carrier ring, a conductive adhesive backing and a substrate, in accordance with an embodiment.

FIG. 2 is an illustration of a block diagram of a processing tool, in accordance with an embodiment of the invention.

FIGS. 3A-3C illustrate cross-sectional views of a semiconductor wafer including a plurality of integrated circuits during a method of dicing a semiconductor wafer, in accordance with an embodiment of the invention.

FIG. 3D is an illustration of a carrier ring assembly that includes a substrate that has been diced into individual dies, in accordance with an embodiment of the invention.

FIG. 4 is a graphical illustration of the dissipation time of an exemplary charge regulating material, in accordance with an embodiment of the invention.

FIG. 5A is an illustration of an end effector, in accordance with an embodiment of the invention.

FIG. 5B is an illustration of an end effector supporting a carrier ring assembly, in accordance with an embodiment of the invention.

FIGS. 5C and 5D are cross-sectional illustrations of an end effector supporting a carrier ring assembly, in accordance with an embodiment of the invention.

FIG. 6A is an illustration of an end effector, in accordance with an embodiment of the invention.

FIG. 6B is an illustration of an end effector supporting a carrier ring assembly, in accordance with an embodiment of the invention.

FIG. 7A is an illustration of an end effector, in accordance with an embodiment of the invention.

FIG. 7B is an illustration of an end effector supporting a carrier ring assembly, in accordance with an embodiment of the invention.

FIGS. 7C and 7D are cross-sectional illustrations of an end effector supporting a carrier ring assembly, in accordance with an embodiment of the invention.

FIG. 8A is an illustration of an end effector, in accordance with an embodiment of the invention.

FIG. 8B is an illustration of an end effector supporting a carrier ring assembly, in accordance with an embodiment of the invention.

FIGS. 8C and 8D are cross-sectional illustrations of an end effector supporting a carrier ring assembly, in accordance with an embodiment of the invention.

FIG. 9A is an illustration of a flowchart representing operations in a method for transferring a carrier ring assembly from a first location to a second location and removing the charge from the carrier ring assembly, in accordance with an embodiment of the invention.

FIGS. 9B and 9C are schematic illustrations of a robot transferring a carrier ring assembly from a first location to a second location, in accordance with an embodiment of the invention.

FIG. 10 illustrates a block diagram of an exemplary computer system, in accordance with an embodiment of the invention.

### DETAILED DESCRIPTION

Methods and apparatuses used for removing static charge from a carrier ring assembly are described in accordance with various embodiments. In the following description, numerous specific details are set forth, such as substrates supported by substrate carrier rings, end effectors, and semiconductor processing tools, in order to provide a thorough understanding of embodiments of the present invention. It will be apparent to one skilled in the art that embodiments of the present invention may be practiced without these specific details. In other instances, well-known aspects are not described in detail in order to not unnecessarily obscure embodiments of the invention. Furthermore, it is to be understood that the various embodiments shown in the Figures are illustrative representations and are not necessarily drawn to scale.

Embodiments of the invention include methods and apparatuses for removing static charge from a carrier ring assembly. The structure of a carrier ring assembly provides unique challenges in the removal of the excess charge. For example, a carrier ring assembly includes a carrier ring and a substrate that are electrically isolated from each other by a non-conductive backing tape. Both the carrier ring and the substrate may acquire a static charge during various processing operations as well. Accordingly, both the substrate and the carrier ring must be individually contacted in order to completely remove the static charge from the carrier ring assembly. Furthermore, only the carrier ring can be contacted on its backside because the substrate is directly supported by the non-conductive backing tape. Accordingly, direct contact with both components from the backside of the carrier ring assembly is not possible.

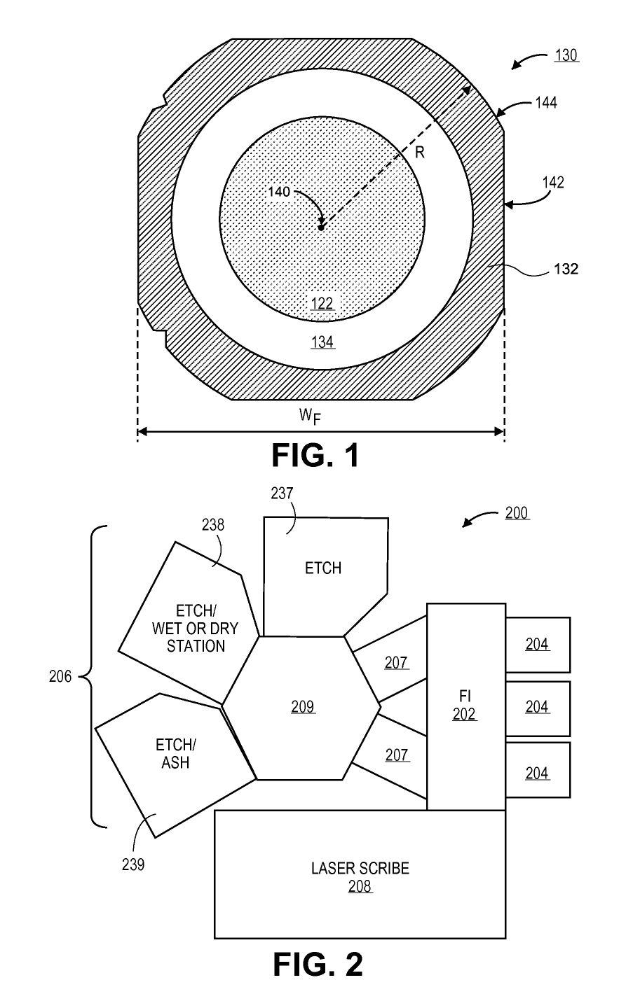

Referring now to FIG. 1, a carrier ring assembly 130 is shown according to an embodiment. In an embodiment, the carrier ring assembly 130 includes a carrier ring 132, an adhesive backing tape 134 and a substrate 122. The layer of adhesive backing tape 134 is surrounded by the carrier ring 132. The substrate 122 is supported by the backing tape 134. According to an embodiment of the invention the backing tape 134 is a conductive material. For example, the backing tape 134 may include a polymeric material that is doped with conductive particles. In an embodiment, the conductive particles may include nano-sized particles, such as copper, carbon, or titanium. According to an additional embodiment of the invention, the backing tape 134 may include a conductive mesh. A conductive backing tape 134 allows for charge that builds up on the substrate 122 to be dissipated. Instead of being electrically isolated from the carrier ring 132, substrate 122 may be electrically coupled to the carrier ring 132 by the conductive backing tape 134. As such, the charge on the substrate may be dissipated through the conductive backing tape 134 into the carrier ring 134. Additionally, the charge acquired by the substrate 122 may be dissipated through the conductive backing tape 134 and into an object supporting the carrier ring assembly 130 and in contact with the conductive backing tape 134. Accordingly, direct contact between the substrate 122 and a charge removing surface is no longer required according to embodiments of the invention. Such embodiments, therefore, allow for the excess charge in the carrier ring 132 and the substrate 122 to be discharged via contact to the backside of the carrier ring assembly 130.

In an embodiment, the carrier ring 132 is a metallic material. For example, the carrier ring 132 is a stainless steel. Embodiments include a carrier ring 132 that is formed from a magnetic material. In an additional embodiment, the carrier ring 132 is a non-metallic material, such as a plastic or a resin based material. Plastic carrier rings 132 provide additional challenges when removing charge from the carrier ring assembly 132 since the charge acquired by the substrate 122 cannot dissipate through the conductive backing tape 134 and into the carrier ring 132. Accordingly, embodiments of the invention described in greater detail below include a path to dissipate the charge from the substrate 122 by contacting the backing tape 134 with a charge regulating surface of an end effector.

In an embodiment, the substrate 122 is a commercially available silicon wafer, such as a 300 mm silicon wafer. Additional embodiments include a carrier ring assembly 130 sized for carrying a larger or smaller substrate, such as 200 mm or 450 mm substrates. Substrate 122 may have a plurality of individual device dies (not shown) that each include integrated circuitry formed thereon.

While specific reference is made herein to carrier ring assemblies 130 that include substrates 122 that are wafers, embodiments are not so limited. Substantially similar methods and apparatuses to those described herein may be used to remove charge acquired by a carrier ring assembly 130 that supports substrates other than single silicon wafers. For example, carrier ring assemblies 130 for carrying multiple substrates may be utilized according to embodiments of the invention. For example, the static charge acquired by a carrier ring assembly 130 utilized for processing light emitting diodes (LEDs) formed on a plurality of sapphire substrates may be removed according to embodiments of the invention.

In an embodiment, carrier ring 132 has one or more flat edges 142. As shown in FIG. 1, the carrier ring 132 includes four flat edges 142. In an embodiment, the width of the carrier ring 132 between opposing flat edges W_{F} is approximately 380 mm, though embodiments are not limited to such configurations. For example, a carrier ring 132 for carrying a larger substrate 122 may have a width W_{F} greater than 380 mm. Embodiments include a carrier ring 132 that has curved edges 144 that are formed between flat edges 144. In an embodiment, the curved edges 144 are circular arcs with an origin at the center 140 of the carrier ring assembly 130. In an embodiment the radius R of the rounded edges 144 may be approximately 200 mm, though embodiments are not limited to such configurations. For example, a carrier ring 132 for carrying a larger substrate 122 may have rounded edges 144 that have a radius R greater than 200 mm. Accordingly, the width of the carrier ring 132 is variable depending on the angular orientation about the center point 140. For example, the width between two points on opposite sides of the carrier ring 132 along the rounded edges 144 (i.e., 2R) is larger than the width W_{F} between two flat edges 142.

According to embodiments of the invention, the carrier ring assembly 130 may support the substrate 122 during a processing operation. For example, the carrier ring assembly 130 may be processed in a processing tool such as one similar to the process tool 200 illustrated in FIG. 2. In an embodiment, a process tool 200 includes one or more load ports 204 and a factory interface 202. The process tool 200 may include a cluster tool 206 that is coupled to the factory interface 202 by load locks 207. The cluster tool includes a chamber 209 in which a robot, such as a robot that has an end effector with one or more charge regulating surfaces (described in greater detail below) transfers carrier ring assemblies 130 between the load locks 207 and a process chamber, or between different process chambers in a vacuum environment 209. In an embodiment, the cluster tool 206 also includes one or more plasma etch chambers 237. In an embodiment, the process tool 200 includes a laser scribe apparatus 208. A process tool 200 may be configured to perform a hybrid laser and etch singulation process of individual device dies formed on a substrate 122, such as a silicon wafer that is supported by a carrier ring 132.

In an embodiment, the laser scribe apparatus 208 houses a femtosecond-based laser. The femtosecond-based laser may be suitable for performing a laser ablation portion of a hybrid laser and etch singulation process of individual device dies formed on a substrate 122, such as a silicon wafer that is supported by a carrier ring 132. In one embodiment, a moveable stage is also included in the laser scribe apparatus 208, the moveable stage configured for moving a substrate 122 supported by a carrier ring 132 relative to the femtosecond-based laser. In another embodiment, the femtosecond-based laser is also moveable.

In an embodiment, the one or more plasma etch chambers 237 in the cluster tool 206 may be suitable for performing an etching portion of a hybrid laser and etch singulation process of individual device dies formed on a substrate 122, such as a silicon wafer that is supported by a carrier ring 132. An etch chamber may be configured for etching a substrate 122 supported by a carrier ring 132 through the gaps in a patterned mask. In one such embodiment, the one or more plasma etch chambers 237 in the cluster tool 206 is configured to perform a deep silicon etch process. In a specific embodiment, the one or more plasma etch chambers is an Applied Centura® Silvia™ Etch system, available from Applied Materials of Sunnyvale, Calif., USA. The etch chamber may be specifically designed for a deep silicon etch used to singulated integrated circuits housed on or in single crystalline silicon substrates or wafers. In an embodiment, a high-density plasma source is included in the plasma etch chamber to facilitate high silicon etch rates.

In an embodiment, the factory interface 202 may be a suitable atmospheric port to interface with the load ports 204, with the laser scribe tool 208, and with the load locks 207. The factory interface 202 may include one or more robots with arms and one or more end effectors for transferring carrier ring assemblies 130 from front opening unified pods (FOUPs) docked at the load ports 204 into either load locks 207 or laser scribe apparatus 208, or both.

Cluster tool 206 may include other chambers suitable for performing functions in a method of singulation. For example, in one embodiment, in place of an additional etch chamber, a deposition chamber 239 is included. The deposition chamber 239 may be configured for mask deposition on or above a device layer of a wafer or a substrate prior to laser scribing of the wafer or substrate. In one such embodiment, the deposition chamber 239 is suitable for depositing a water soluble mask. In another embodiment, in place of an additional etch chamber, a wet/dry station 238 is included. The wet/dry station 238 may be suitable for cleaning residues and fragments, or for removing a water soluble mask, subsequent to a laser scribe and plasma etch singulation process of a substrate or a wafer. In an embodiment, a metrology station is also included as a component of process tool 200.

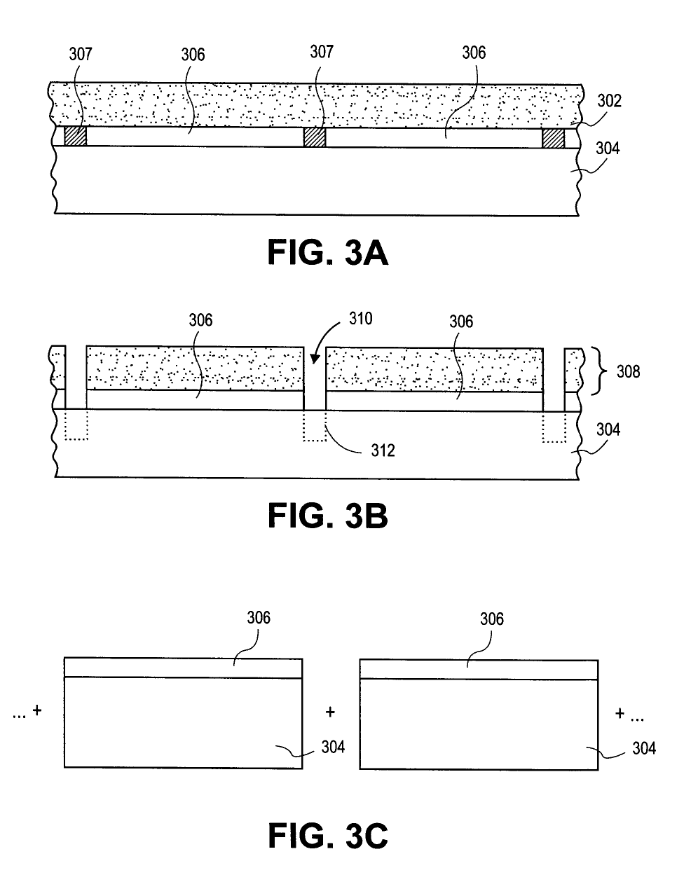

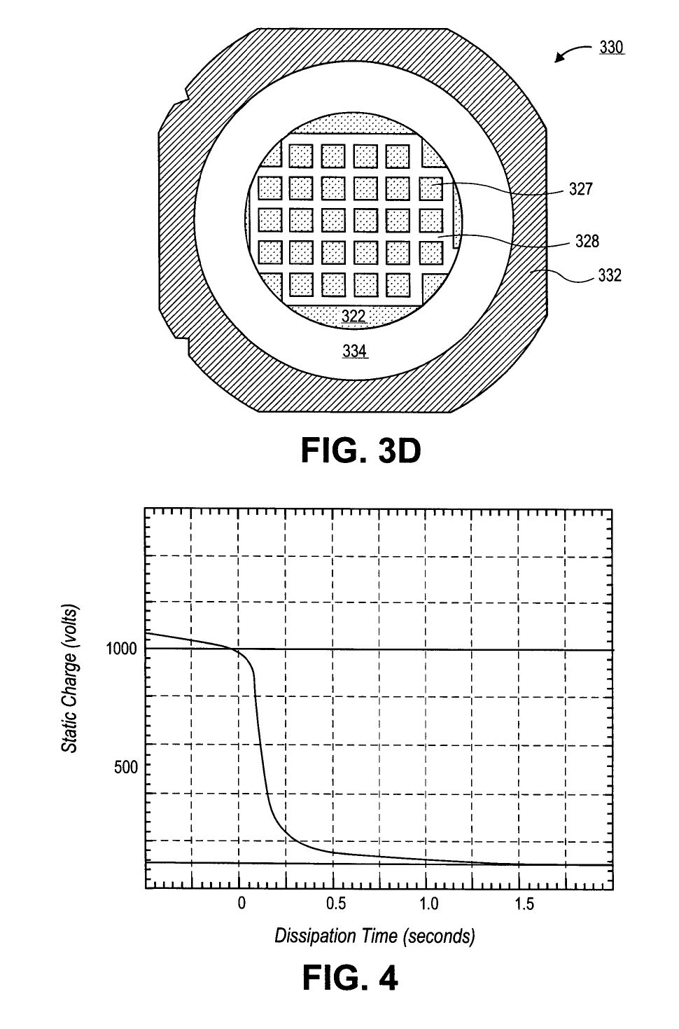

According to an embodiment, a hybrid laser and etch singulation process may include a process such as the one illustrated in FIGS. 3A-3C. Referring to FIG. 3A, a mask 302 is formed above a semiconductor wafer or substrate 304. The mask 302 is composed of a layer covering and protecting integrated circuits 306 formed on the surface of semiconductor wafer 304. The mask 302 also covers intervening streets 307 formed between each of the integrated circuits 306.

Referring to FIG. 3B, the mask 302 is patterned with a laser scribing process to provide a patterned mask 308 with gaps 310, exposing regions of the semiconductor wafer or substrate 304 between the integrated circuits 306. As such, the laser scribing process is used to remove the material of the streets 307 originally formed between the integrated circuits 306. In accordance with an embodiment of the present invention, patterning the mask 302 with the laser scribing process further includes forming trenches 312 partially into the regions of the semiconductor wafer 304 between the integrated circuits 306, as depicted in FIG. 3B.

Referring to FIG. 3C, the semiconductor wafer 304 is etched through the gaps 310 in the patterned mask 308 to singulate the integrated circuits 306. In accordance with an embodiment of the present invention, etching the semiconductor wafer 304 includes ultimately etching entirely through semiconductor wafer 304, as depicted in FIG. 3C, by etching the trenches 312 initially formed with the laser scribing process. In one embodiment, the patterned mask 308 is removed following the plasma etching, as is also depicted in FIG. 3C.

Accordingly, referring again to FIGS. 3A-3C, wafer dicing may be performed by initial ablation using a laser scribing process to ablate through a mask layer, through wafer streets (including metallization) and, possibly, partially into a substrate or wafer. Die singulation may then be completed by subsequent through-substrate plasma etching, such as through-silicon deep plasma etching. For example, FIG. 3D illustrates a carrier ring assembly 330 that has undergone a hybrid laser and etch singulation process. The substrate 322 has been singulated into individual dies 327 separated by vertical and horizontal gaps 328. During the hybrid laser and etch singulation process, static charge may be acquired by each die 327. Accordingly, embodiments of the invention include apparatuses and methods for discharging each die 327 in a controlled manner in order to prevent sparking.

Instead of having to contact each individual die 327 to remove the charge, embodiments of the invention include charge regulating surfaces that can contact a conductive backing tape 334 to allow the dissipation of charge from all of the dies 327 with a single contact point. Furthermore, embodiments of the invention include charge regulating surfaces on the end effector so the charge dissipation can occur as the carrier ring assembly is transferred from the processing tool to a second location, such as a cassette or a subsequent processing chamber. As such, embodiments of the present invention allow for reductions in the time needed for discharging the dies 327 and reduces the complexity of the discharging operation because each individual die 327 does not need to be contacted.

According to embodiments of the invention, the charge that is built up on the carrier ring assembly 130 is dissipated in a controlled manner. Controlling the rate of dissipation prevents arcing between the carrier ring assembly and the surface used for dissipating the charge. For example, if a carrier ring assembly that has acquired a charge is contacted with a highly conductive material, such a metallic material, then charge may completely dissipate within several microseconds or less, and may cause an arc between the two materials. Arcing has the potential to damage the integrated circuitry formed on the substrate or on the dies and is, therefore, not desirable.

Embodiments of the invention include removing the charge from the carrier ring assembly 130 at a slower rate by contacting the charged carrier ring assembly 130 with charge regulating surfaces. For example, charge regulating surfaces may include materials with resistivities that are higher than metallic materials. In an embodiment, the resistivity of a charge regulating surface may be between 10⁴ ohm-cm and 10¹¹ ohm-cm. The higher resistivity reduces the rate at which the charge is dissipated and prevents arcing. For example, FIG. 4 is a graph showing the charge dissipation of titania doped aluminum oxide, which is one of several materials that may be used as a charge regulating surface according to embodiments of the invention. As shown, the charge is almost fully dissipated by 0.25 seconds, with the remainder of the charge being substantially removed by about 1.25 seconds. This exemplary rate of dissipation demonstrates that the charge on the carrier ring assembly can be removed at a rate that is orders of magnitude larger than the rate that would result in arcing, such as when static charge is dissipated in several microseconds or less. According to additional embodiments of the invention, the charge regulating surface may include other materials such as, but not limited to, titanium oxide, titanium nitride, carbon doped polyether ether ketone (PEEK), or diamond like coatings.

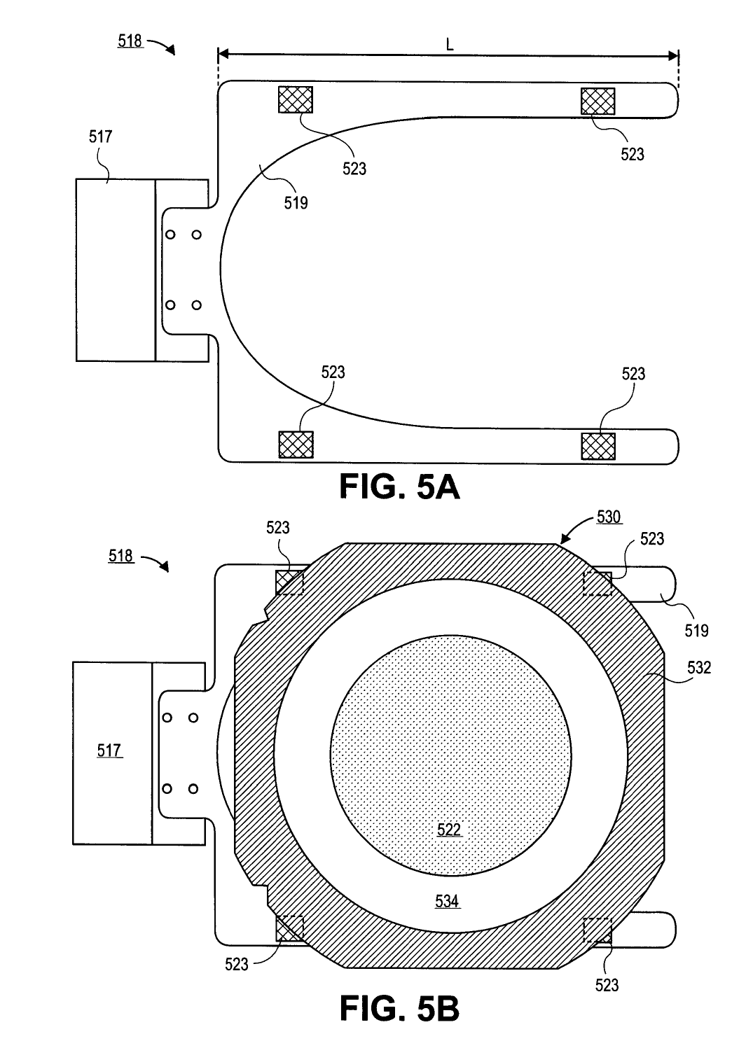

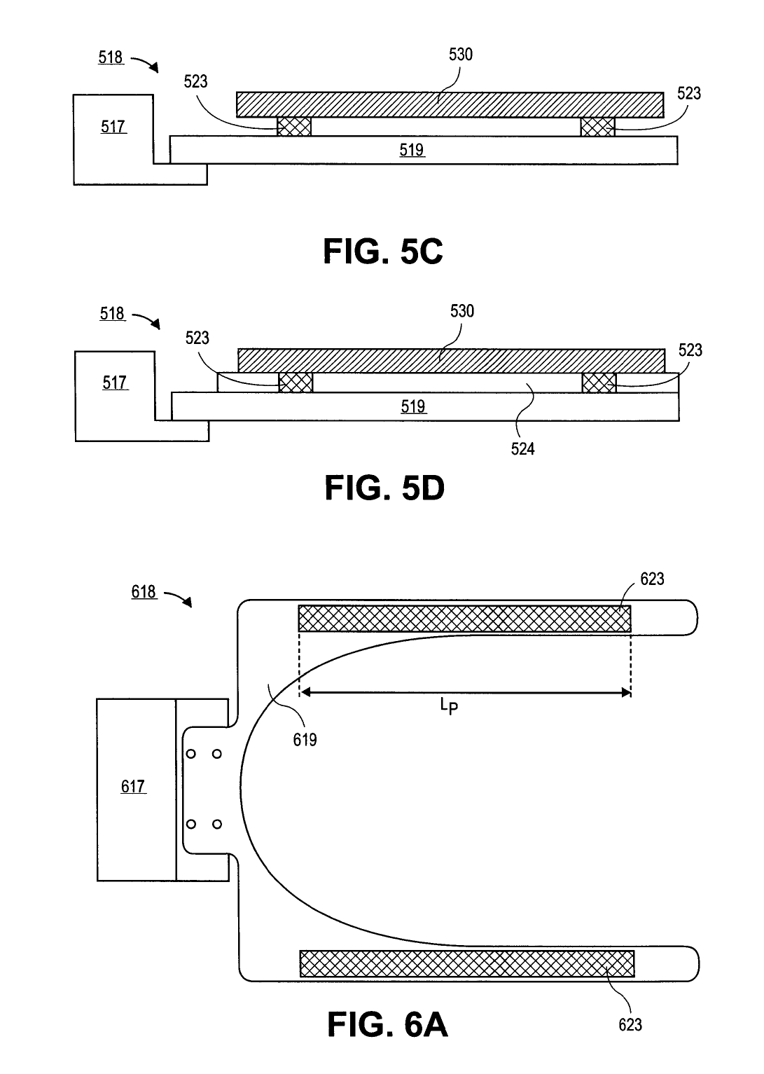

In addition to the materials chosen for the charge regulating surfaces, the surface area of the charge regulating surface that is in contact with the carrier ring assembly 130 also influences the rate at which the charge is dissipated from the carrier ring assemblies 130. A larger surface area will dissipate charge faster relative to a smaller surface area of the same material. FIGS. 5A-8D illustrate several end effectors with varying configurations of charge regulating surfaces according to embodiments of the invention.

Referring now to FIG. 5A, an overhead view of a robot arm 518 is illustrated according to an embodiment of the invention. Robot arm 518 includes an end effector wrist 517. The end effector wrist 517 may be coupled to an end effector 519. The robot arm 518 may also be coupled to a wafer handling robot (not shown). For example, the wafer handling robot may be a selective compliance articulated robot arm (SCARA) or any other wafer handling robot known in the art. The end effector 519 extends outwards from the end effector wrist 517. As illustrated, the end effector 519 includes two prongs that extend outwards for supporting a carrier ring assembly 530. Additional embodiments include an end effector that includes two or more prongs that are not formed as a single component, each of which is coupled to the end effector wrist 517. In an embodiment, the end effector 519 extends outwards a length L that is sufficient for supporting a carrier ring assembly 530. For example, the length L may be larger than the width W_{F} of the carrier ring assembly. According to an additional embodiment, the length L may be less than the width W_{F} of the carrier ring assembly. Embodiments of the invention may also include a gripping mechanism (not shown) to secure a carrier ring assembly to the end effector 519 during the transfer of the carrier ring assembly between locations. For example, the gripping mechanism may be a mechanical grip, an electromagnetic grip, or a vacuum grip. Additional embodiments do not include a gripping mechanism. For example, friction between the carrier ring assembly 530 and the end effector 519 may supply sufficient force to secure the carrier ring assembly 530 to the end effector 519 during the transfer of a carrier ring assembly from a first location to a second location.

According to an embodiment, end effector 519 may be substantially formed from a metallic material. As such, embodiments include a plurality of charge regulating surfaces that are formed over a surface of the end effector 519 in order to prevent arcing between the carrier ring assembly 530 and the metallic end effector 519. According to an embodiment, the charge regulating surfaces include a plurality of pads 523, as illustrated in FIG. 5A. The pads dissipate charge stored in the carrier ring assembly and transfer it to the metallic blades. The current may then be transferred to the end effector wrist 517 and ultimately to ground by the robot coupled to the end effector wrist 517. According to an embodiment illustrated in FIG. 5A, the end effector 519 includes four pads 523. However, it is to be appreciated, that embodiments of the invention are not limited to such configurations. For example, an end effector 519 may also include three or more pads 523.

In an embodiment, the pads 523 may be coupled to the end effector 519 by screws (not shown) or other fasteners known in the art. In order to prevent arcing, the fasteners may be an insulative material, such as a plastic. In an embodiment, the pads 523 are sized to provide sufficient support to the carrier ring assembly 530 and are large enough to adequately dissipate the charge acquired by the carrier ring assembly 130. According to an embodiment, the pads may be 15 mm by 15 mm squares. Additional embodiments include pads that are larger or smaller in size and formed as shapes other than squares. For example, the pads 523 may have edges that are between 5 mm and 20 mm in length.

Referring now to FIG. 5B, an end effector 519 that is supporting a carrier ring assembly 530 is illustrated according to an embodiment of the invention. As shown, the end effector 519 spans across the entire width W_{F} of the carrier ring assembly 530. According to an embodiment, the pads 523 are in contact with the carrier ring 532. As such, charge may be dissipated from the carrier ring 532 through the pads 523. In an additional embodiment, additional pads 523 may optionally be formed at locations along the end effector 519 that will provide contact with the conductive backing tape 534 as well. In such embodiments, the additional pads 523 provide an additional pathway for discharging the substrate 522 supported by the conductive backing tape 534. However, embodiments of the invention without pads 523 contacting the backing tape 534 may still discharge the substrate 522 because the charge from the substrate may pass through the conductive backing tape 534 and into the carrier ring 532.

As illustrated in the cross-sectional view of the robot arm 518 in FIG. 5C, the pads 523 extend upwards above the end effector 519. In an embodiment, the pads 523 are thick enough to space the carrier ring assembly a distance above the end effector 519 to prevent arcing between the carrier ring assembly 530 and the end effector 519. By way of example, the pads 523 may have a height between 1 mm and 5 mm. Additional embodiments may include pads 523 that that have a height between 2 mm and 3 mm. An additional embodiment illustrated in FIG. 5D includes an insulative layer 524 formed over the exposed portions of the mend effector 519. In such embodiments, the insulative layer 524 prevents arcing between the blades and the carrier ring assembly. By way of example, the insulative layer may be a polymeric material.

In embodiments of the invention, the insulative layer 524 may be recessed below the pads 523 or the insulative layer 524 may be substantially the same thickness as the pads 523. In embodiments that have an insulative layer that is substantially the same thickness as the pads 523, the insulative layer 524 may further be used to increase the friction between the carrier ring assembly 530 and the end effector 519. In an embodiment, the insulative layer 524 may be a compliant material. According to an embodiment of the invention, the insulative layer 524 may be a material that is between 50 and 100 durometers. Embodiments of the invention may include an insulative layer 524 that is between 55 and 70 durometers. The use of a compliant material increases the contact area between the carrier ring assembly 530 and the end effector 519. For example, an end effector 519 formed from a rigid material may not allow the entire surface of the carrier ring 532 to contact the end effector 519 due to the variation in thickness of the carrier ring 532, which may be 0.1 mm or greater. In contrast, a compliant insulative layer 524 can conform to the variations in thickness of the carrier ring 532 and provide improved contact between the two surfaces.

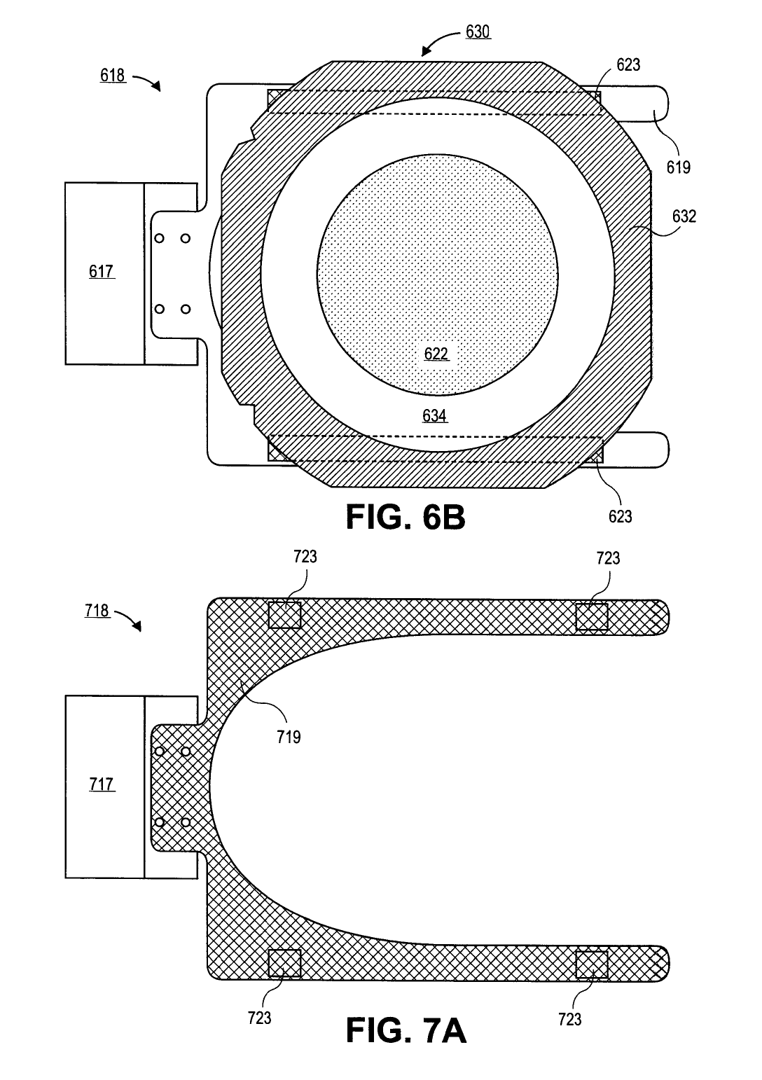

Referring now to FIG. 6A, a robot arm 618 according to an additional embodiment of the invention is illustrated. According to an embodiment, robot arm 618 is substantially similar to robot arm 518 described above with respect to FIGS. 5A-5D, with the exception of the configuration of the pads 623 on the end effector 619. As illustrated, the pads 623 may extend substantially the entire length of the end effector 619. For example, each pad 623 may have a length L_{P} that extends substantially along the length L of the end effector. As shown in FIG. 6B, the extended length of the pads 623 allows for the pads 623 to contact both the carrier ring 632 and the conductive backing tape 634. As such, the carrier ring 632 and the substrate 622 supported by the conductive backing tape 634 can be discharged. Additionally, the increased surface area of the pads 623 that is in contact with the carrier ring assembly 630 may increase the rate at which the excess charge is dissipated from the carrier ring assembly 630. Those skilled in the art will recognize that the increased rate at which the charge is dissipated is still orders of magnitude slower than if the carrier ring assembly was contacted directly with a metallic surface, and therefore no arcing between the components will occur.

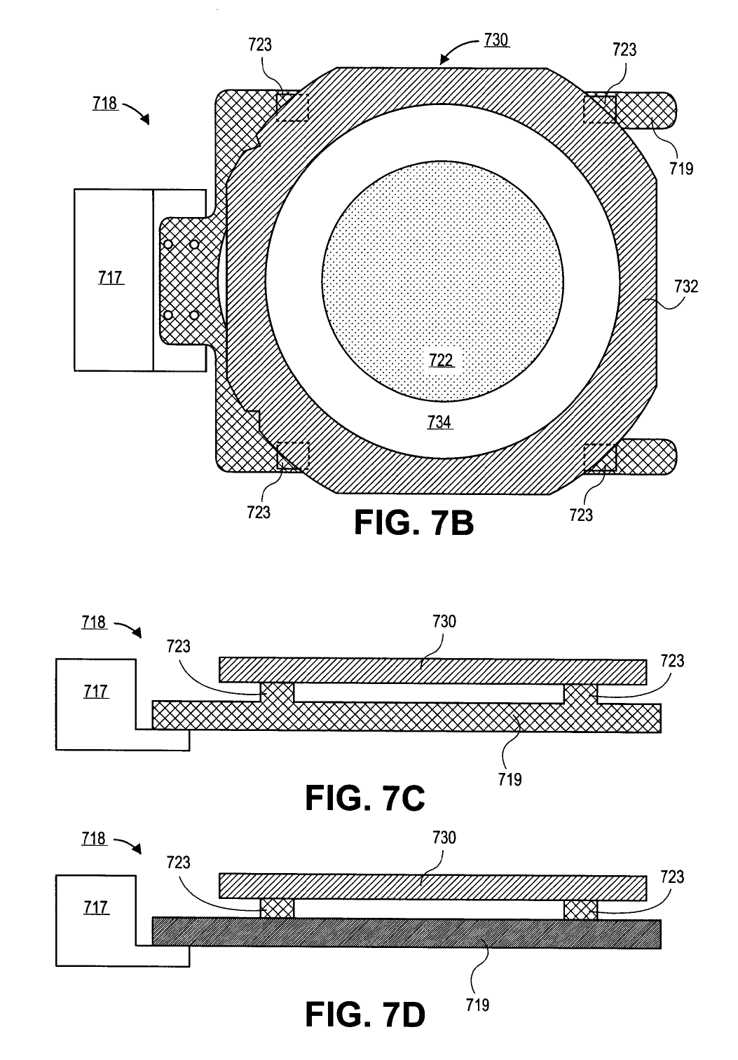

Referring now to FIG. 7A, an end effector according to an additional embodiment is illustrated. The robot arm 718 is substantially similar to the robot arm 518 illustrated in FIG. 5A, with the exception that the end effector 719 may be made from the charge regulating material instead of a metallic material. As shown in FIG. 7B, a carrier ring assembly 730 is supported on the pads 723 in substantially the same manner as described with respect to FIG. 5B. While the entire end effector 719 is formed from a charge regulating material, only a smaller area of the charge regulating material (i.e., the pads 723) is in contact with the carrier ring assembly 730. Similar to above, the rate at which the charge is removed can be increased by increasing the area of the pads 723. Further, since the entire end effector 719 is formed from the charge regulating material, the resistance of the end effector 719 may also be increased relative to an end effector that includes metallic materials. Embodiments may also include adjusting the cross-sectional area of the end effector 719 to allow more or less current to flow through the end effector 719, thereby providing an additional parameter that may be used to control the rate of charge removal from the carrier ring assembly 730.

In embodiments, the pads 723 and the end effector 719 are formed from a single component, as illustrated in the cross-sectional view shown in FIG. 7C. Additional embodiments include forming the end effector 719 and pads 723 as separate components that are coupled together by fasteners, for example by plastic screws. According to an embodiment, the end effector 719 may be formed from a first charge regulating material and the pads 723 may be formed from a second charge regulating material, as illustrated in FIG. 7D. The combination of different materials may provide additional design flexibility for obtaining a desired charge removal rate. For example, a first charge regulating material used for the end effector 719 may have a lower resistivity than a second charge regulating material used for the pads 723. As such, the charge removal rate of may be reduced because the higher resistivity material is in contact with the carrier ring assembly 730. Alternatively, embodiments may include a first charge regulating material used for the end effector 719 that has a lower resistivity than a second charge regulating material used for the pads 723. Additionally, the end effector 719 may be formed from a charge regulating material that is lighter and stiffer than the pads 723 in order to reduce the amount that the end effector droops.

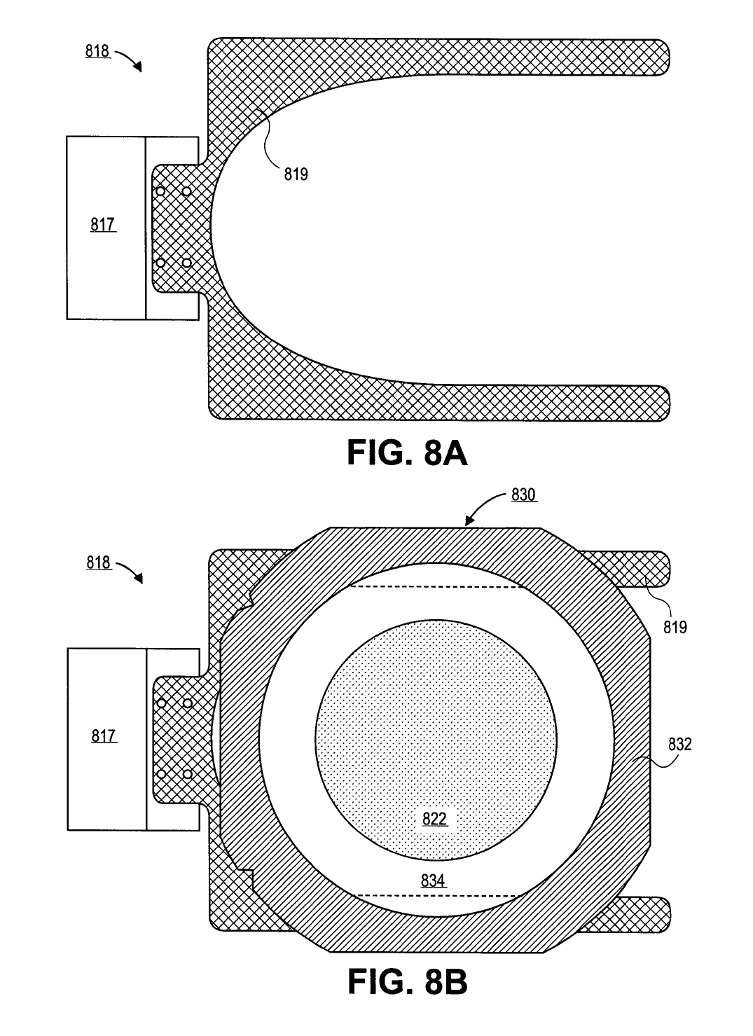

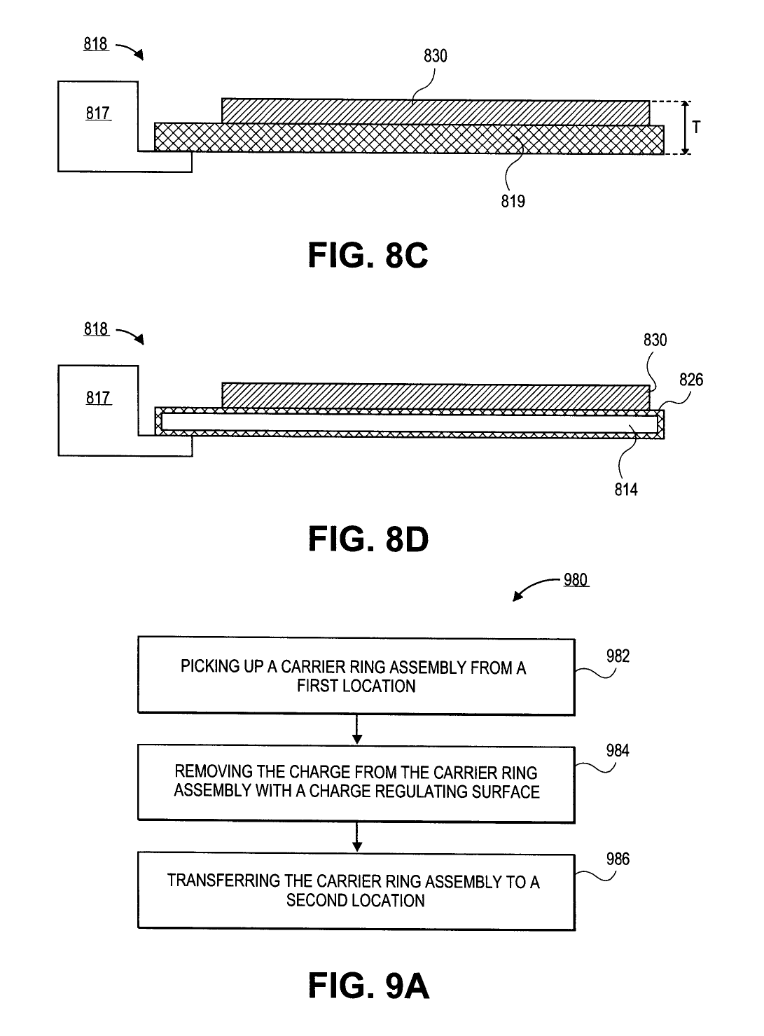

Referring now to FIG. 8A, a robot arm 818 according to an additional embodiment is illustrated. Robot arm 818 is substantially similar to robot arm 718 with the exception that there are no pads 723 on the end effector 719. In such an embodiment, the carrier ring assembly 830 may be in direct contact with an end effector 819 that is formed with the charge regulating material. Accordingly, the entire surface of an end effector 819 may be a charge regulating surface in accordance with embodiments of the invention. As illustrated in FIG. 8B, the carrier ring assembly 830 may be contacted along the backside of the carrier ring 832 and the conductive backing tape 834, thereby providing paths for discharging the carrier ring 832 and the substrate 822.

In an embodiment, omitting the pads decreases the combined thickness T of the carrier ring assembly 830 and the end effector 819, as shown in FIG. 8C. Reducing the thickness allows the end effector to fit into tighter pitched cassettes. For example, carrier ring assemblies 830 may have a thickness that is approximately 1.5 mm or greater, whereas a commercially available silicon wafer may have a thickness that is approximately 750 μm or less. Accordingly, when transferring the thicker carrier rings 832 in a processing tool designed for thinner substrates, such as a 300 mm silicon wafer substrate, the thickness of the carrier ring assembly 830 becomes an obstacle. Accordingly, reducing the thickness of the end effector 819 provides addition clearance in tightly pitched storage cassettes or narrow openings, and improves the reliability of a process tool.

According to an embodiment, the charge regulating material may be a surface coating 826 applied over an end effector core 814, as illustrated in the cross-sectional view in FIG. 8D. For example, the end effector core 814 may be a metallic material. As such, the electrical discharge path flows from the carrier ring assembly into the charge regulating surface coating, and then into the metallic core. The material used for the end effector core 814 may also be chosen to provide the required stiffness to the end effector 819. For example, a rigid material, such as a non-conductive ceramic, or a metallic material may be utilized. According to an embodiment, the end effector core 814 does not need to be conductive because the surface coating 826 may provide the necessary conductive path between the carrier ring assembly 830 and the end effector wrist 817.

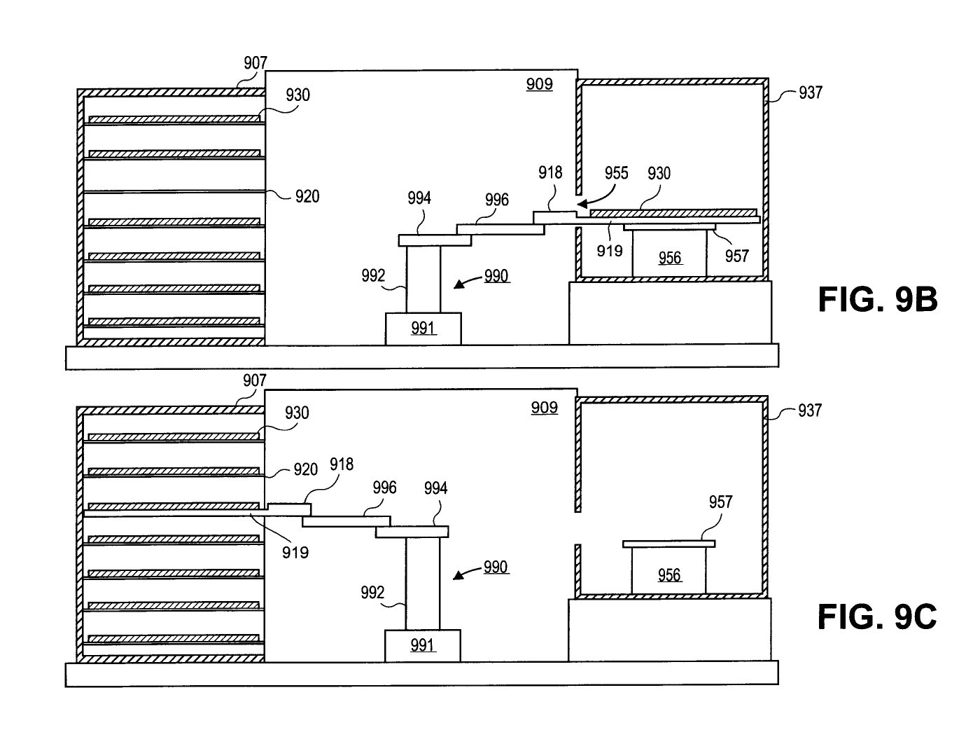

According to embodiments, a carrier ring assembly is transferred from a first location to a second location with an end effector that removes the charge from the carrier ring assembly during the transfer process. FIG. 9 includes a flowchart 980 representing operations in a process for transferring and removing the charge of a carrier ring assembly, according to an embodiment. FIGS. 9B-9C illustrate a cross-sectional view of an end effector robot 990 that includes an end effector 919 during performance of a process for transferring and removing the charge from a carrier ring assembly 930, corresponding to operations of flowchart 980, in accordance with an embodiment.

Referring now to operation 982 of flowchart 980, and corresponding FIG. 9B, an end effector 919 picks up a carrier ring assembly 930 from a first location. According to an embodiment, the end effector 919 is coupled to a robot 990. In an embodiment, the robot 990 includes a robot drive 991. A robot shaft 992 may extend out of a top surface of the robot drive 991 in order to enable the robot to raise or lower the level of an end effector 919. In an embodiment, the robot shaft 992 is driven by a piston or a lead screw. According to an embodiment, the robot arm may be a selective compliance articulated robot arm (SCARA). For example, a first arm 994 is rotatably coupled to the robot shaft 992. A second arm 996 may be rotatably coupled to the free end of the first arm 994. The end effector 919 may be rotatably coupled to the free end of the second arm 996.

According to an embodiment, the first location is the chuck 957 in a plasma processing chamber 937. The chuck 957 may be supported by a pedestal 956. As illustrated, the end effector 918 enters into the processing chamber 937 through an opening slot 955. While the first location is illustrated as a processing chamber, those skilled in the art will recognize that the first location may be any location accessible to the robot 990. For example, the first location may also be a slot 920 in a load lock chamber 907.

Referring now to operation 984 of flowchart 980, the charge is removed from the carrier ring assembly with a charge regulating surface on the end effector 919. According to embodiments of the invention, the charge regulating surface on the end effector may include any of the configurations described herein. Accordingly, charge is removed from the carrier ring assembly at a controlled rate to prevent arcing between the carrier ring assembly 930 and the end effector 919. According to embodiments of the invention the charge is removed during the process of transferring the carrier ring assembly 930 from the first location to the second location.

Referring now to operation 986 of flowchart 980 and corresponding FIG. 9C, the carrier ring assembly is transferred to a second location. For example, the second location may include a slot 920 in a load lock chamber 907. According to additional embodiments, the second location may be any location accessible to the robot 990. For example, the second location may include an additional processing chamber, such as a wet/dry station or a laser scribing station.

Referring now to embodiments of the present invention may be provided as a computer program product, or software, that may include a machine-readable medium having stored thereon instructions, which may be used to program a computer system (or other electronic devices) to perform a process according to embodiments of the present invention. In one embodiment, the computer system is coupled with process tool 200 described in association with FIG. 2 or with the robot 990 described in association with FIG. 9B. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., infrared signals, digital signals, etc.)), etc.

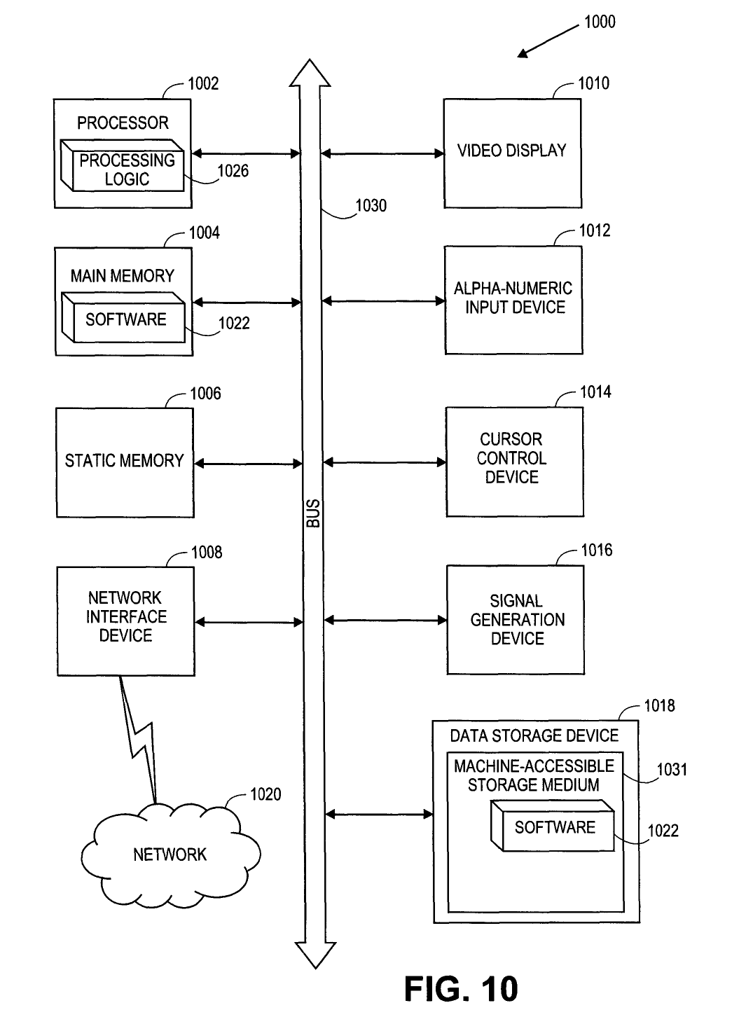

FIG. 10 illustrates a diagrammatic representation of a machine in the exemplary form of a computer system 1000 within which a set of instructions, for causing the machine to perform any one or more of the methodologies described herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies described herein.

The exemplary computer system 1000 includes a processor 1002, a main memory 1004 (e.g., read-only memory (ROM), flash memory, dynamic random access memory (DRAM) such as synchronous DRAM (SDRAM) or Rambus DRAM (RDRAM), etc.), a static memory 1006 (e.g., flash memory, static random access memory (SRAM), etc.), and a secondary memory 1018 (e.g., a data storage device), which communicate with each other via a bus 1030.

Processor 1002 represents one or more general-purpose processing devices such as a microprocessor, central processing unit, or the like. More particularly, the processor 1002 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 1002 may also be one or more special-purpose processing devices such as an application specific integrated circuit (ASIC), a field programmable gate array (FPGA), a digital signal processor (DSP), network processor, or the like. Processor 1002 is configured to execute the processing logic 1026 for performing the operations described herein.

The computer system 1000 may further include a network interface device 1008. The computer system 1000 also may include a video display unit 1010 (e.g., a liquid crystal display (LCD), a light emitting diode display (LED), or a cathode ray tube (CRT)), an alphanumeric input device 1012 (e.g., a keyboard), a cursor control device 1014 (e.g., a mouse), and a signal generation device 1016 (e.g., a speaker).

The secondary memory 1018 may include a machine-accessible storage medium (or more specifically a computer-readable storage medium) 1031 on which is stored one or more sets of instructions (e.g., software 1022) embodying any one or more of the methodologies or functions described herein. The software 1022 may also reside, completely or at least partially, within the main memory 1004 and/or within the processor 1002 during execution thereof by the computer system 1000, the main memory 1004 and the processor 1002 also constituting machine-readable storage media. The software 1022 may further be transmitted or received over a network 1020 via the network interface device 1008.

While the machine-accessible storage medium 1031 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present invention. The term “machine-readable storage medium” shall accordingly be taken to include, but not be limited to, solid-state memories, and optical and magnetic media.

In accordance with an embodiment of the present invention, a machine accessible storage medium has instructions stored thereon which cause a data processing system to perform a method of picking up a carrier ring assembly from a first location with an end effector having charge regulating surfaces. The method may further include removing the charge from the carrier ring assembly with the charge regulating surfaces. The method may further include transferring the carrier ring assembly to a second location.

1. A method of removing charge from a carrier ring assembly, comprising:
picking up a carrier ring assembly from a first location with an end effector, wherein the carrier ring assembly comprises a carrier ring, a conductive adhesive backing tape surrounded by the carrier ring, and a substrate supported by the conductive adhesive backing tape, and wherein the carrier ring assembly has acquired a charge;
removing the charge with one or more charge regulating surfaces formed on an end effector at a rate that prevents arcing; and
transferring the carrier ring assembly to a second location with the end effector.

2. The method of claim 1, wherein the charge regulating surfaces are pads formed on a top surface of the end effector.

3. The method of claim 2, wherein the pads are in contact with a metallic layer of the end effector.

4. The method of claim 3, wherein the top surface of the metallic layer that is not in contact with the pads is covered by an insulative material.

5. The method of claim 2, wherein the end effector is formed from the same material as the pads.

6. The method of claim 1, wherein the charge regulating surface is the entire surface of the end effector.

7. The method of claim 6, wherein the charge regulating surface is a surface coating applied over the end effector.

8. The method of claim 1, wherein picking up the carrier ring assembly from the first location includes contacting a portion of the conductive adhesive backing tape with the charge regulating surfaces.

9. The method of claim 8, wherein removing the charge from the carrier ring assembly includes removing charge from the substrate supported on the conductive adhesive hacking tape.

10. The method of claim 9, wherein the substrate is a plurality of die that were diced prior to the carrier ring assembly being picked up at the first location, and wherein charge is removed from each die.

11. The method of claim 1, wherein the charge regulating surfaces have a resistivity between 10⁴ ohm-cm and 10¹¹ ohm-cm.

12. The method of claim 1, wherein the charge regulating surfaces include one or more of carbon doped polyether ether ketone (PEEK), titanium doped alumina, titanium nitride, titanium oxide, and diamond like coatings.

13. A robot arm, comprising:
an end effector wrist;
an end effector extending out from the end effector wrist;
one or more charge regulating surfaces formed on the end effector; and
an insulating layer that covers an exposed top surface of the end effector, wherein a top surface of the insulating layer is substantially coplanar with a top surface of the charge regulating surfaces.

14. The robot arm of claim 13 wherein the charge regulating surfaces are pads that extend up from a top surface of the end effector.

15. The robot arm of claim 14, wherein charge regulating surfaces extend substantially along the length of the end effector.

16. (canceled)

17. The robot arm of claim 13, wherein the charge regulating surfaces cover the surface of the end effector.

18. The robot arm of claim 13, wherein the charge regulating surfaces include one or more of carbon doped polyether ether ketone (PEEK), titanium doped alumina, titanium nitride, titanium oxide, and diamond like coatings.

19. The robot arm of claim 13, wherein the charge regulating surfaces are positioned to contact a carrier ring and a conductive adhesive backing tape surrounded by the carrier ring.

20. A method of removing charge from a carrier ring assembly, comprising:
picking up a carrier ring assembly from a first location with an end effector, wherein the carrier ring assembly has acquired a charge;
removing the charge with one or more charge regulating surfaces formed on an end effector at a rate that prevents arcing, wherein the charge regulating surfaces have a resistivity between 10⁴ ohm-cm and 10¹¹ ohm-cm, and wherein the charge regulating surfaces contact a portion of a carrier ring and a portion of a conductive adhesive backing tape surrounded by the carrier ring with the charge regulating surfaces; and
transferring the carrier ring assembly to a second location with the end effector.
